(19) United States
(12) Patent Application Publication
(10) Pub. No.: US 2026/0219546 A1
(43) Pub. Date: Jul. 30, 2026

(54) A NANOCRYSTAL-BASED SUPER-OSCILLATOR LENS

(71) Applicant: BILKENT UNIVERSITESI ULUSAL NANOTEKNOLOJI ARASTIRMA MERKEZI, Ankara (TR)

(72) Inventors: Emre UNAL, Ankara (TR); Hilmi Volkan DEMIR, Ankara (TR); Evren MUTLUGUN, Ankara (TR); Ozgun AKYUZ, Ankara (TR)

(73) Assignee: BILKENT UNIVERSITESI ULUSAL NANOTEKNOLOJI ARASTIRMA MERKEZI, Ankara (TR)

(21) Appl. No.: 19/146,236

(22) PCT Filed: Jan. 30, 2024
(86) PCT No.: PCT/TR2024/050071

§ 371 Date: Jul. 8, 2025

(30) Foreign Application Priority Data
Jan. 30, 2023 (TR) 2023/001030

(51) Int. Cl. G02F 1/355; G02F 1/35

(52) U.S. Cl. CPC G02F 1/3551; G02F 1/3509; G02F 2202/108

(57) ABSTRACT

The present invention relates to a super-oscillator lens which absorbs part of photons received from a low-wavelength laser source and then converts it into one or more different higher-wavelength photons and serves to focus these photons on a focal plane.

### TECHNICAL FIELD

The present invention relates to a super-oscillator lens which absorbs part of photons received from a low-wavelength laser source and then converts it into one or more different higher-wavelength photons and serves to focus these photons on a focal plane.

### BACKGROUND OF THE INVENTION

It is possible to achieve imaging at higher resolution by exceeding the optical diffraction limit by means of optical lenses and/or components (e.g. AFM-SNOM type) used in current confocal, near-field scanning optical (NSOM) and similar microscopes. Super-oscillator lenses can be used to exceed the diffraction limit. However, in the current situation, these lenses are designed depending on the laser wavelength used in the microscope system and imaging can only be performed at the related wavelength. In cases where a plurality of lasers with different wavelengths are used by being aligned, this can be performed via a lens design that will provide achromaticity depending on the related wavelengths, however the structure becomes optically complex and the production becomes difficult.

Therefore, in order to overcome the above-stated shortcomings, there is need for developing a nanocrystal-based super-oscillator lens.

The United States patent document no. US2004150818—an application included in the state of the art—discloses an optical parametric oscillator which is comprised of at least one light source, such as a laser, and a medium made up of nanoparticles and which is a light emitting device. The nanoparticles included in the oscillator may be non-aggregated nanoparticles and/or aggregated nanoparticles. Here, the aggregated nanoparticles comprise fractals. Fractal aggregates of nano-sized particles provide a dramatic enhancement for various linear and nonlinear optical responses, including Raman Scattering (RS) and Hyper-Raman Scattering (HRS), and elongation at wavelengths.

### SUMMARY OF THE INVENTION

An objective of the present invention is to realize a super-oscillator lens which absorbs part of photons received from a low-wavelength laser source and then converts it into one or more different higher-wavelength photons and serves to focus these photons on a focal plane.

### DETAILED DESCRIPTION OF THE INVENTION

“A Nanocrystal-Based Super-Oscillator Lens” realized to fulfil the objective of the present invention is shown in the figure attached, in which:

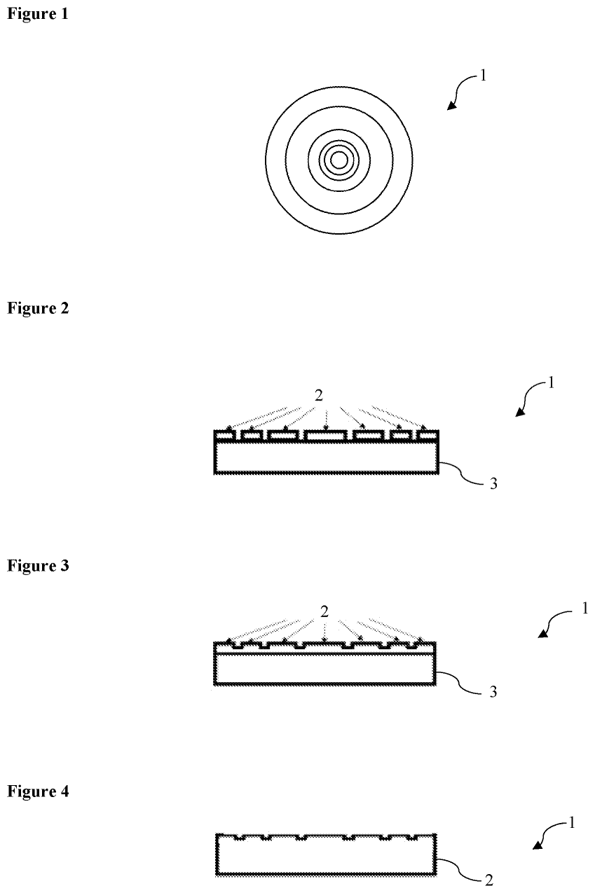

FIG. 1 is a top view of the inventive super-oscillator lens.

FIG. 2 is a sectional view of the inventive super-oscillator lens.

FIG. 3 is another sectional view of the inventive super-oscillator lens.

FIG. 4 is a further sectional view of the inventive super-oscillator lens.

The components illustrated in the figures are individually numbered, where the numbers refer to the following:
1. Super-oscillator lens
2. Nanocrystal
3. Substrate

The inventive super-oscillator lens (1) which absorbs part of photons received from a low-wavelength laser source and then converts it into one or more different higher-wavelength photons and serves to focus these photons on a focal plane, comprises
at least one nanocrystal (2) which is used to absorb photons received from a laser source and then to convert them into higher-wavelength photons; and
at least one substrate (3) which form a basis for insertion of the nanocrystal (2).

The nanocrystal (2) included in the inventive super-oscillator lens (1) is a cadmium or indium-based nanocrystal. The nanocrystal (2) is in the form of quantum dots or quantum wells. In one example of the invention, the nanocrystal (2) has a CdSe/ZnS core/shell or core/crown structure. The nanocrystals (2) are transformed into a mixture form or a film form embedded in a polymer, by being added into a solvent solution in the form of hexane and toluene and then mixed with a magnetic stirrer or by being added into a polymer liquefied by heating. The thenanocrystal (2) is combined with polymers in the form of polymethylmethacrylate (PMMA), polyethylene (PE) or polystyrene (PS).

The substrate (3) included in the inventive super-oscillator lens (1) is made of any of transparent materials in the form of glass, silica, quartz, polymethylmethacrylate (PMMA), boron-silicate and serves as a layer for the delivery of the nanocrystals (2).

The inventive super-oscillator lens (1) is obtained by coating the polymer-nanocrystal (2) mixture or film on the substrate (3) by means of any of the methods such as spin-coating, dip-coating, sprey, doctor-blade and shaping by means of any of the methods such as molecular imprint, photolithography, embossing (FIGS. 2 and 3). In another embodiment of the invention, the super-oscillator lens (1) is obtained as a structure consisting of only the polymer-nanocrystal (2) layer without the substrate (3) by means of any of the methods such as die-casting, injection molding, blow molding (FIG. 4).

With the inventive super-oscillator lens (1), it will be possible to perform imaging at one or more wavelengths simultaneously at higher resolution by exceeding the optical diffraction limit at different wavelengths depending on the emission of the nanocrystals (2) used.

Within these basic concepts; it is possible to develop various embodiments of the inventive “Nanocrystal-Based Super-Oscillator Lens (1)”; the invention cannot be limited to examples disclosed herein and it is essentially according to claims.

1. A super-oscillator lens (1) which absorbs part of photons received from a low-wavelength laser source and then converts it into one or more different higher-wavelength photons and serves to focus these photons on a focal plane, comprising:
at least one nanocrystal (2) which is used to absorb photons received from a laser source and then to convert them into higher-wavelength photons; and characterized by
at least one substrate (3) which form a basis for insertion of the nanocrystal (2).

2. A super-oscillator lens (1) according to claim 1; characterized by thenanocrystal (2) which is a cadmium or indium-based nanocrystal.

3. A super-oscillator lens (1) according to claim 1; characterized by the thenanocrystal (2) which is in the form of quantum dots or quantum wells.

4. A super-oscillator lens (1) according to claim 1; characterized by the thenanocrystal (2) one example of which has a CdSe/ZnS core/shell or core/crown structure.

5. A super-oscillator lens (1) according to claim 1; characterized by the thenanocrystals (2) which are transformed into a mixture form or a film form embedded in a polymer, by being added into a solvent solution in the form of hexane and toluene and then mixed with a magnetic stirrer or by being added into a polymer liquefied by heating.

6. A super-oscillator lens (1) according to claim 5; characterized by the nanocrystal (2) which is combined with polymers in the form of poly methylmethacrylate (PMMA), polyethylene (PE) or polystyrene (PS).

7. A super-oscillator lens (1) according to claim 1; characterized by the substrate (3) which is made of any of transparent materials in the form of glass, silica, quartz, poly methylmethacrylate (PMMA), boron-silicate and serves as a layer for the delivery of the nanocrystals (2).

8. A super-oscillator lens (1) according to claim 1; which is obtained by coating the polymer-nanocrystal (2) mixture or film on the substrate (3) by means of any of the methods such as spin-coating, dip-coating, sprey, doctor-blade and shaping by means of any of the methods such as molecular imprint, photolithography, embossing.

9. A super-oscillator lens (1) according to claim 1; which is obtained as a structure consisting of only the polymer-nanocrystal (2) layer without the substrate (3) by means of any of the methods such as die-casting, injection molding, blow molding.
